(19) United States
(12) Patent Application Publication
(10) Pub. No.: US 2016/0063458 A1
(43) Pub. Date: Mar. 3, 2016

(54) Methods and systems to improve compliance in wellness programs for the chronically ill

(71) Applicant: Daro Bryon GROSS, Monte Sereno, CA (US)

(72) Inventor: Daro Bryon GROSS, Monte Sereno, CA (US)

(73) Assignee: Daro Bryon Gross, Los Gatos, CA (US)

(21) Appl. No.: 14/121,407

(22) Filed: Sep. 2, 2014

(51) Int. Cl. G06Q 20/10

(52) U.S. Cl. CPC G06Q 20/10

(57) ABSTRACT

This is a method and system by which monetary incentives may be used to motivate compliance to a wellness program that targets management of chronic illnesses. This invention provides administrators of wellness programs with methods and systems for refunding wellness program participant health insurance co-payments and payments made according to a health insurance deductible according to two distinct criteria: (1) how much effort the wellness program participant has invested in complying with the wellness program and (2) how successful the wellness program participant is in complying with the wellness program. By adjusting the size of the refund portions and the time intervals between the refunds, an administrator of a wellness program can achieve an optimal and rational method and system for motivating individuals with chronic illnesses to comply with the objectives of a wellness program. Moreover, this method and system of monetary incentives targets only those wellness program participants that invest in complying with the objectives of a wellness program.

### CROSS-REFERENCES TO RELATED APPLICATIONS

This application is a continuation-in-part of pending U.S. patent application Ser. No. 14/121,189, filed 11 Aug. 2014, which claims the benefit of provisional patent application Ser. No. 61/964,085, filed Dec. 23, 2013, both of which are hereby incorporated by reference in their entirety.

### FIELD

The invention relates to a method and system for administering health insurance benefits to motivate a wellness program participant according to participant monetary investment in achieving compliance with a wellness program, and more particularly, for wellness programs that target the management of chronic conditions.

### BACKGROUND

Chronic illnesses impose large economic burdens on the economy in terms of healthcare dollars, absenteeism, lost productivity, and mortality. To combat the rising costs of chronic illnesses, employers, in particular, have turned to wellness programs as a strategy to address this problem. A wellness program is useful in controlling the costs of chronic illnesses when the program is effective in modifying participant behavior over long periods of time with respect to better management of chronic conditions.

However, there is a lack of methods and systems that are effective in motivating consistent efforts to manage chronic illnesses in a wellness program. Accordingly, a need exists for methods and systems that are effective in motivating the chronically ill to better manage their chronic illnesses within the context of a wellness program.

### RELATED ART

The prior art describes methods and systems for incentivizing participants in wellness programs with monetary and non-monetary rewards of many kinds. These inventions have proven to be ineffective in motivating the long-term efforts required to manage chronic illnesses, primarily, because they do not motivate participation in terms of the day-to-day efforts required to successfully manage chronic illnesses. Managing chronic illness within the context of wellness programs requires effective methods and systems for motivating participants on an ongoing basis. The present invention fulfills these needs and provides further related advantages as described in the following summary.

### SUMMARY OF THE INVENTION

The present invention concerns novel methods and systems for encouraging individuals with chronic illnesses to perform health-promoting measures within the context of a wellness program. In particular, the present invention promotes long-term, consistent behavior modification by creating incentives that reward compliance in both efforts to perform, and success in performing, health-promoting behaviors. To do so, the present invention provides methods and systems for refunding wellness program participant monetary payments made under the terms of a health insurance plan.

There are two methods of evaluating participation in a wellness program by individuals with chronic illnesses. The first method involves monitoring the real-time probability of participant efforts to comply with a wellness program. The second method measures participant wellness program compliance with respect to objective baseline measurements for success. The present invention is novel in that it provides for an optimal allocation of incentives to wellness program participants with chronic illnesses.

In one embodiment, methods and systems are provided for implementing and/or administering incentives according to wellness program participant health insurance cost centers, namely, co-payments and payments made according to a health insurance deductible. Participant efforts to comply with a wellness program are monitored in real-time, and the probability of compliance is calculated to determine the method by which some portion of the co-payments and payments made according to a health insurance deductible are refunded at future times. At the same time, measurement of participant success in complying with a wellness program is established through objective measurements, such as through diagnostic screening, to determine the method by which some portion of co-payments and payments made according to a health insurance deductible are refunded at future times.

This novel combination of methods and systems is effective in motivating participants with chronic illnesses to comply with a wellness program because it provides for independent motivation for good faith efforts as well as actual success in the management of chronic illnesses.

### DETAILED DESCRIPTION OF THE INVENTION

Before describing the present invention in detail, it is to be understood that this invention is not limited to particularly exemplified methods or systems that may, of course, vary. It is to be understood that the terminology used herein is for the purpose of describing particular embodiments of the invention only, and is not intended to limit the scope of the invention in any manner.

The present invention is a method and system for using monetary incentives to motivate participation in wellness programs targeted at chronically ill individuals. To do so, the present invention relies on the availability of two kinds of data about participant compliance to a wellness program. First, the present invention requires that there be available real-time data of the probability that a participant is compliant with the wellness program. Second, the invention requires that there be available objective measurement of compliance with the wellness program. The present invention also requires accounting of the monetary payments made by wellness program participants in managing chronic illnesses in the form of health insurance co-payments and/or payments made according to a health insurance deductible.

The preferred embodiment of the present invention provides for two methods and systems for refunding portions of the monetary payments made by a wellness program participant. In the first method and system, a portion of the co-payments and payments made according to a health insurance deductible is refunded according to the current measurement of the probability that a participant is compliant with the wellness program, e.g., real-time monitoring of wellness program compliance. In the second method and system, a portion of the co-payments and payments made according to objective measurement of compliance with the wellness program, e.g., a diagnostic screening program. In both methods and systems, monetary payments made by a wellness program participant are held for determined periods of time in order that the amount of moneys to be refunded to a wellness program participant increase over time. This feature increases wellness program participant motivation to comply with the wellness program by increasing the amount of moneys to be refunded over time.

While the invention has been described with reference to one preferred embodiment, it is to be clearly understood by those skilled in the art that the invention is not limited thereto. Rather, the scope of the invention is to be interpreted only in conjunction with the claims.

Having described my invention, I claim:

1. A method and system for refunding moneys to a wellness program participant that:
a. maintains a current total of the amount of moneys paid as health insurance co-payments.
b. maintains a current total of the amount of moneys paid according to a health insurance deductible.
c. allows for calculation of the portion of moneys paid by a wellness program participant in 1(a) and 1(b) to be refunded according to a current measurement of the probability that a participant is compliant with the wellness program.
d. allows for calculation of the portion of moneys paid by a wellness program participant in 1(a) and 1(b) to be refunded according to an objective measurement that a participant is compliant with the wellness program.

2. The method and system of 1 further compromising a means for determining the time intervals between payments to program participants that:
a. have a maximum probability of compliance with the wellness program.
b. have a maximum objective measurement of compliance with the wellness program.
